(19) United States
(12) Patent Application Publication
(10) Pub. No.: US 2018/0091490 A1
(43) Pub. Date: Mar. 29, 2018

(54) AUTHENTICATION FRAMEWORK FOR A CLIENT OF A REMOTE DATABASE

(71) Applicant: Apple Inc., Cupertino, CA (US)

(72) Inventors: Hui WANG, San Mateo, CA (US); James C. QUIGGINS, San Jose, CA (US); Clay A. MAECKEL, Poth, TX (US); Fan ZHAO, San Jose, CA (US)

(21) Appl. No.: 15/275,237

(22) Filed: Sep. 23, 2016

(51) Int. Cl. H04L 29/06; H04L 29/08

(52) U.S. Cl. CPC H04L 63/08; H04L 63/12; H04L 67/10; H04L 67/20; H04L 67/02; H04L 63/18

(57) ABSTRACT

Disclosed herein is a technique for authenticating an application operating on a client device with an authentication server device based on user credentials associated with an identity provider. In particular, the authentication server device facilitates the authorization process between the application and the identity provider without exposing, to the application, either the user credentials or an authorization code generated by the identity provider.

### FIELD

The described embodiments set forth a technique for authenticating an application with an authorization server via an identity provider.

### BACKGROUND

OAuth (Open Authorization) is an open standard for authorization that allows users to authorize third-party applications to access protected resources that are hosted by an identity provider (e.g., Google, Facebook, Twitter, etc.) without sharing their login credentials. Specifically, OAuth is a web-based authorization technique that involves the communication of an authorization code between the identity provider and the third-party application to provide the access to the protected resources. However, communication of the authorization code directly to the third-party application can cause security issues. For instance, malware installed on a client device (on which the third-party application operates) can obtain the authorization code that can then be used for malicious purposes, e.g., inappropriately gaining access to the protected resources. Therefore, there is a need for a technique for more-securely authenticating third-party applications via identity providers.

### SUMMARY

Representative embodiments set forth herein disclose various techniques for enabling an application operating on a client device to authenticate with an authentication server device by way of an identity provider. According to some embodiments, the authentication is performed without exposing a user's credentials (for the identity provider) to the application/authentication server device. As described in greater detail herein, the techniques involve the communication of an authorization code from a web browser operating on the client device to the authentication server device. The authorization code is associated with an authentication request issued by the web browser to the identity provider, where the authentication request includes login information that is known to the identity provider and is associated with the user of the application. In turn, the authentication server device generates an authorization identifier in response to a successful verification of the authentication request. The authorization identifier is communicated to the web browser, where, in turn, the web browser provides the authorization identifier to the application. The application can then utilize the authorization identifier to authenticate with the authentication server device. In this manner, the authentication server device facilitates the authorization process between the application and the identity provider without communicating the authorization code directly to the application, which can enhance overall security by strengthening the barrier against potential man-in-the-middle attacks.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

Other aspects and advantages of the embodiments described herein will become apparent from the following detailed description taken in conjunction with the accompanying drawings that illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system configured to implement the various techniques described herein, according to some embodiments.

FIGS. 2A-2C illustrate sequence diagrams of a method for authorizing an application operating at a client device in a secure manner, according to some embodiments.

FIG. 3 illustrates a method that is carried out at an authentication server device, according to some embodiments.

FIG. 4 illustrates a method that is carried out at a client device, according to some embodiments.

FIG. 5 illustrates a detailed view of a computing device that can represent the various computing devices described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The embodiments described herein set forth techniques for facilitating an authorization process between an application and an identity provider. In particular, the techniques involve redirecting an authorization code generated by the identity provider to an authentication server device rather than directly to the application. In turn, the authentication server device generates an authorization identifier based on the authorization code. The authorization identifier then is returned to the application and used by the application to authenticate with the authentication server device.

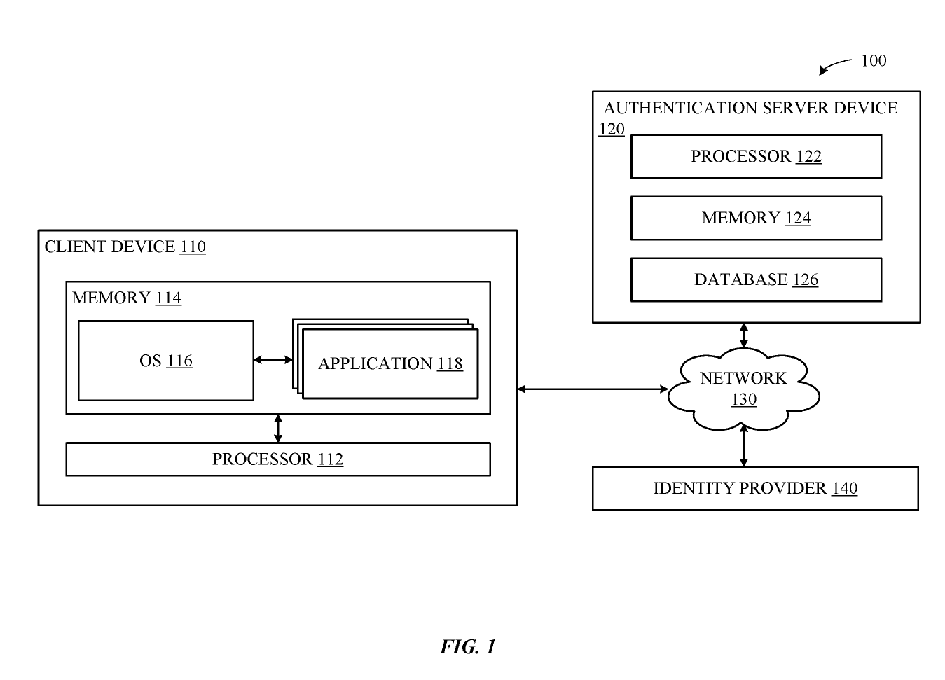

Accordingly, the techniques described herein provide a mechanism for authenticating the application operating on a client device with the authentication server device in a secure manner. A more detailed discussion of these techniques is set forth below and described in conjunction with FIGS. 1, 2A-2C, and 3-5, which illustrate detailed diagrams of systems and methods that can be used to implement these techniques.

FIG. 1 illustrates a block diagram of different components of a system 100 that is configured to implement the various techniques described herein, according to some embodiments. More specifically, FIG. 1 illustrates a high-level overview of the system 100, which, as shown, includes a client device 110 that can represent a computing device (e.g., a smartphone device, a tablet device, a laptop computer, a desktop computer, etc.). A processor (or central processing unit (CPU)) 112, in conjunction with the memory 114, can implement an operating system (OS) 116 configured to execute various applications 118 (e.g., native OS applications, user applications, etc.) and other processes/services on the client device 110. According to some embodiments, and as described in greater detail herein, applications 118 operating on the client device 110 can include an application—referred to herein as the application 118—seeking authorization to communicate with an authentication server device 120 and access information stored at a database 126 associated with the authentication server device 120. According to some embodiments, the authorization can be based on provided user credentials associated with an identity provider 140. In some implementations, the application 118 can include a FileMaker® software application seeking authorization to communicate with an authentication server device 120 that hosts database files to be used in conjunction with the FileMaker® software application.

According to some embodiments, the client device 110, the authentication server device 120, and the identity provider 140 can communicate with one another via a network 130 (e.g., the Internet). The network 130 can include one or more of the Internet, an intranet, a PAN (Personal Area Network), a LAN (Local Area Network), a WAN (Wide Area Network), a MAN (Metropolitan Area Network), a wireless communication network, and other networks or combination of networks.

According to some embodiments, the authentication server device 120 can represent a computing device that is configured to facilitate the authorization process between the application 118 and the identity provider 140. A processor (or CPU) 122, in conjunction with the memory 124, can implement an OS (not illustrated in FIG. 1) that is configured to implement various processes/services to enable the authentication server device 120 to carry out the techniques described herein. In some implementations, the application 118 and the authentication server device 120 can be managed/produced by the same entity, e.g., a software development company, such that the application 118 and the authentication server 118 can trust and effectively communicate with one another. In some implementations, the authentication server device 120 can include a single server or multiple servers that individually or collectively provide authentication/authorization services (as described herein) and provide other services to the application 118 (e.g., access to one or more databases 126). In some implementations, the authentication server device 120 can be implemented as a part of a cloud-based infrastructure, where the authentication server device 120 enables the database 126 to be accessed by the client device 110/application 118 when authorized.

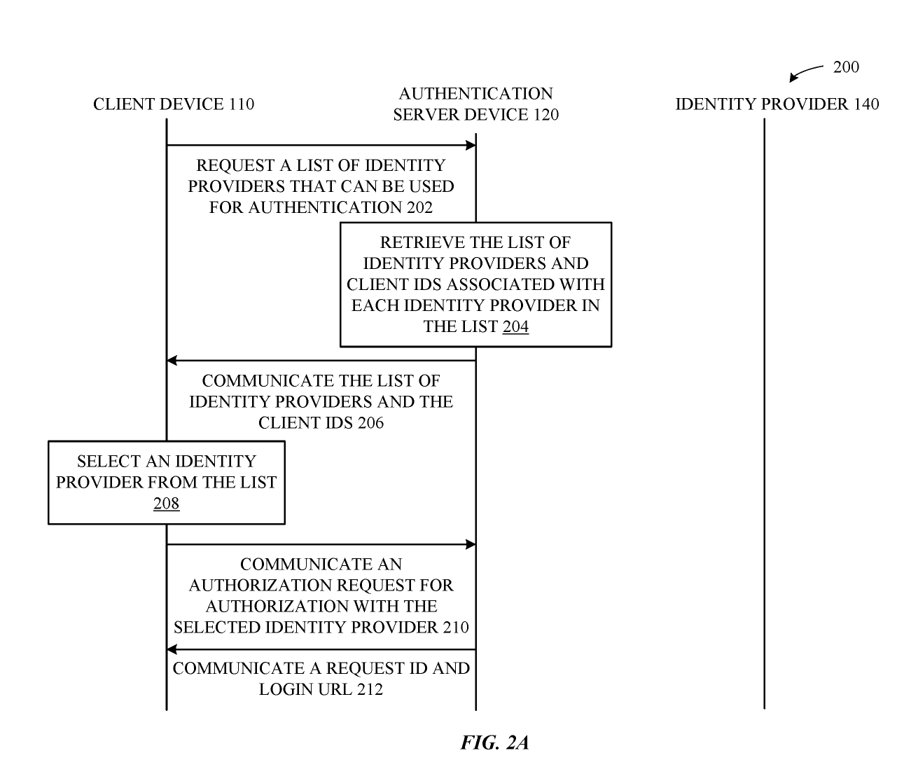

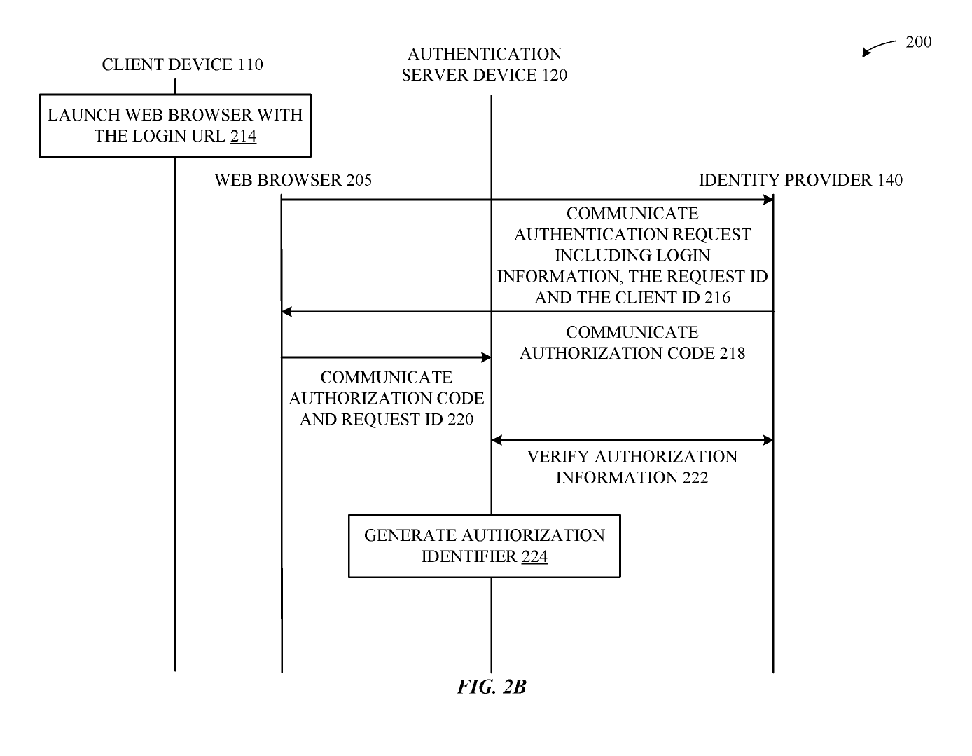

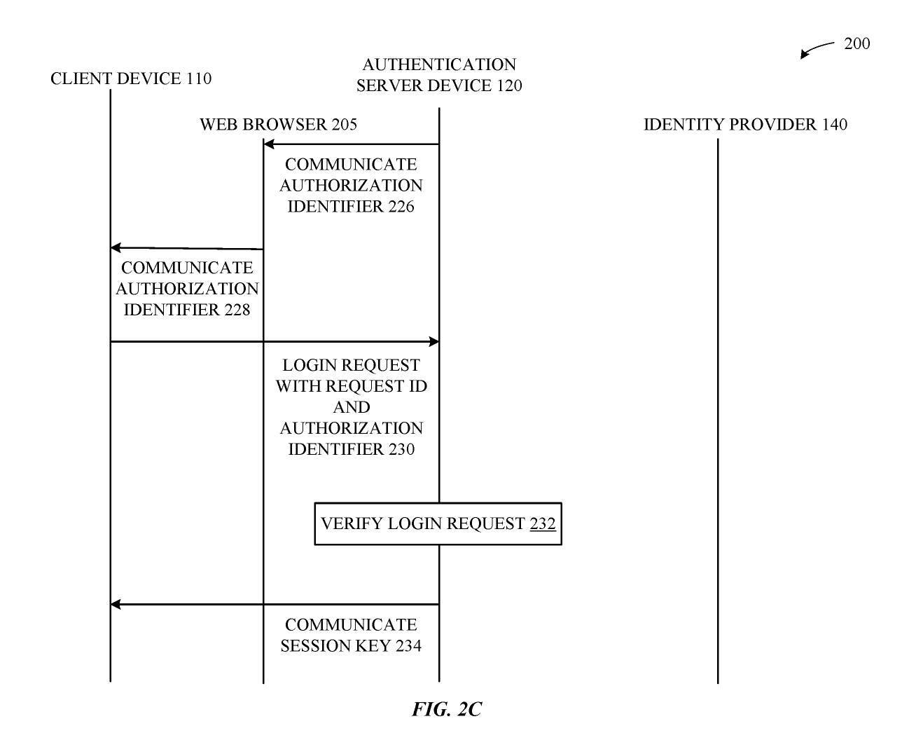

FIGS. 2A-2C illustrate a sequence diagram of a method 200 for authorizing the application 118 operating on the client device 110 to authenticate with the authentication server device 120 via the identity provider 140, according to some embodiments. As shown in FIG. 2A, at step 202, the application 118 communicates, to the authentication server device 120, a request for a list of identity providers that can be used for authorizing/authenticating the application 118. In turn, the authentication server device 120, at step 204, retrieves the list of identity providers 140 and a set of client identifiers (client IDs) associated with those identity providers 140. In some implementations, a particular client ID is issued for the authentication server device 120 when the authentication server device 120 registers to access the authorization services provided by the corresponding identity provider 140. In other words, each identity provider 140 issues/assigns a different client ID for the authentication server device 120 during the registration process.

According to some embodiments, the list of identity providers 140 and the associated client IDs are stored at the authentication server device 120. In some implementations, the authentication server device 120 communicates, at step 206, the retrieved list of identity providers 140 and the client IDs to the application 118.

At step 208, the list of identity providers 140 is presented to the application 118. According to some embodiments, the list of identity providers 140 can be presented in a graphical user interface (GUI) of the application 118. A user of the application 118 can then choose to authenticate with a particular identity provider 140 by selecting the particular identity provider 140 from the list presented in the GUI. At step 210, and in response to the selection of the particular identity provider 140 from the list, an authorization request is communicated from the application 118 to the authentication server device 120, where the authorization request represents a request to authenticate with the selected identity provider 140. At step 212, and in response to receiving the authorization request, the authentication server device 120 returns to the application 118: (1) a request ID associated with the authorization request, and (2) a login URL (Uniform Resource Locator) that enables the application 118 to interface with the selected identity provider 140 to perform an authorization process.

Referring now to FIG. 2B, at step 214, a web browser 205 is launched at the client device 110 with the login URL provided by the authentication server device 120. According to some embodiments, the login URL can cause the web browser 205 to navigate to a website associated with the selected identity provider 140, whereupon the user can be prompted to provide their credentials (e.g., a user ID and password, etc.). In some implementations, the login URL can include a number of parameters, for example, the client ID associated with the authentication server device 120 and/or other parameters.

At step 216, the application 118, via the web browser 205, communicates an authentication request to the identity provider 140, where the authentication request includes login information (e.g., the user's credentials), the request ID (discussed above in conjunction with step 212), the client ID, and a redirect URL that points to the authentication server device 120. At step 218, and in response to the authentication request, the identity provider 140: (1) authenticates the login information, (2) generates an authorization code in response to a successful authentication, and (3) communicates the authorization code to the web browser 205 (executing on the client device 110). At step 220, the web browser 205 redirects the user to the authentication server device 120 based on the redirect URL. The web browser 205 communicates authorization information (including the authorization code and the request ID) to the authentication server device 120. In this manner, the authorization information is returned/redirected to the authentication server device 120 via the web browser 205 without exposing the authorization information to the application 118. In some implementations, the authorization information can be stored at the authentication server device 120.

At step 222, the authorization information is verified with the identity provider 140. In some implementations, the verification process involves verifying, by the identity provider 140, that the user's credentials are authentic. At step 224, in response to a successful verification, the authentication server device 120 generates an authorization identifier based on the request ID and/or the authorization code. In some implementations, the authorization identifier can include a random number, code, secret, and/or the like. The authorization identifier can be stored at the authentication server device 120. In some implementations, the authentication server device 120 can store the request ID, the authorization code, and the authorization identifier linked to the client ID. In some implementations, and in response to an unsuccessful verification, a value associated with the authorization identifier can be set to zero to provide an indication of the unsuccessful verification.

Referring to now FIG. 2C, at step 226, the authentication server device 120 communicates the authorization identifier to the web browser 205. At step 228, the web browser 205 is hidden or terminated, and the authorization identifier is communicated to the application 118. In some implementations, the authorization identifier is returned via an internet protocol that the application 118 registers with the operating system. For example, when the web browser 205 uses the internet protocol, the application 118 is launched (if needed) and the authorization identifier is sent via a URL associated with the registered internet protocol. In some implementations, the application 118 can retrieve (i.e., pull) the authorization identifier from the web browser 205. Alternatively, the web browser 205 can provide (i.e., push) the authorization identifier to the application 118. It is noted that any inter-process communications process can be used to communicate the authorization identifier between the web browser 205 and the application 118. As previously set forth herein, when the authorization identifier value is set to zero, the application 118 understands that the authorization request was unsuccessful.

In some implementations, the web browser 205 can establish/access a corresponding process space in the memory 114. In this scenario, when the application 118 receiving the authorization identifier is not running with any elevated privileges, the contents of the corresponding process space in memory 114 (associated with the web browser 205) and communications of the web browser 205 are highly inaccessible to the application 118. In this manner, the authorization identifier can be securely communicated to the web browser 205 by the authentication server device 120 while reducing the likelihood of exposing the authorization identifier to the application 118.

At step 230, the application 118 communicates a login request to the authentication server device 120. According to some embodiments, the login request includes the request ID and the authorization identifier. In turn, at step 232, the authentication server device 120 verifies the login request. In some implementations, the verification process involves verifying that the request ID and the authorization identifier stored at the authentication server device 120 match the request ID and the authorization identifier included in the login request communicated by the application 118. Next, at step 234, and in response to a successful verification, the authentication server device 120 communicates a session key to the application 118. According to some embodiments, the session key can represent one or more encryption keys that can be used to enable the application 118 to securely access the database 126 of the authentication server device 120.

In some implementations, the authorization identifier generated by the authentication server device 120 is linked to the user/login information/client ID such that the authorization identifier can be used for subsequent login requests. With this approach, it is not necessary to re-generate the authorization identifier for each subsequent authorization/login request. According to some embodiments, the authorization identifier can be valid only for a pre-defined period of time to increase security. In some implementations, when the authentication server device 120 rejects the authorization identifier, the steps depicted in FIGS. 2B and 2C (e.g., launching the web browser 205, communicating with the identity provider 140, etc.) are repeated to ensure that the user has continued access to the database 126.

Accordingly, the authorization process described in conjunction with FIGS. 2A-2C does not require direct communication of the authorization code to the client device 110/application 118. Instead, the authorization code is redirected/returned to the authentication server device 120, which then facilitates the verification and authorization process by generating an authorization identifier based on the request ID and returning the authorization identifier to the client device 110/application 118. Consequently, it is highly difficult for malicious programs that may be executing on the client device 110/monitoring the application 118 to intercept the authorization code, thereby substantially enhancing overall security. In other words, by not requiring direct communication of the authorization code between the identity provider 140 and the client device 110/application 118, man-in-the-middle attacks can be minimized and security of the authorization process can be enhanced.

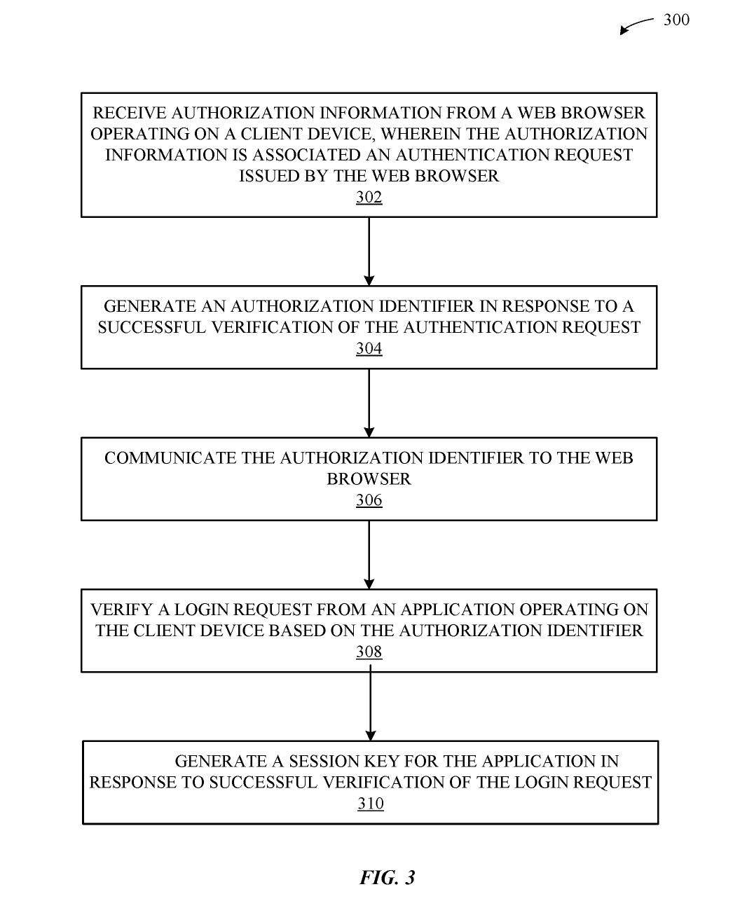

FIG. 3 illustrates a method 300 that is carried out by the authentication server device 120 of FIG. 1, according to some embodiments. As shown in FIG. 3, the method 300 begins at step 302, where the authentication server device 120 receives authorization information from the web browser 205 (executing on the client device 110). As previously described with respect to steps 216, 218, and 220 of FIG. 2B, the authorization information is associated with an authentication request issued by the web browser 205 to the identity provider 140. The authentication request can include login information, a request ID, and a client ID. The authorization information communicated to the authentication server device 120 includes (1) the request ID, and (2) an authorization code provided by the identity provider 140 in response to a successful verification of the authentication request (i.e., verification of the login information by the identity provider 140).

In some implementations, the authorization information, including the authorization code and the request ID, is verified with the identity provider 140, as previously described with respect to steps 222, 224, and 226 of FIGS. 2B and 2C). At step 304, the authentication server device 120 generates an authorization identifier in response to a successful verification of the authorization information. At step 306, the authentication server device 120 communicates the authorization identifier to the web browser 205.

In some implementations, and as previously described with respect to step 230 and 232 of FIG. 2C, the authentication server device 120 receives a login request from the application 118, where the login request includes the request ID and the authorization identifier. At step 308, the authentication server device 120 verifies the login request based on the authorization identifier. The verification can involve determining whether the authorization identifier and/or request ID received from the application 118 matches the authorization identifier and/or request ID stored at the authentication server device 120. In response to a match, the login request is successfully verified.

In some implementations, and as previously described with respect to step 234 of FIG. 2C, the authentication server device 120 enables secure communication between the application 118 and the authentication server device 120 when the login request is successfully verified. According to some embodiments, the authentication server device 120 generates a session key for the client device 110/application 118 that enables the client device 110 to securely communicate with the authentication server device 120.

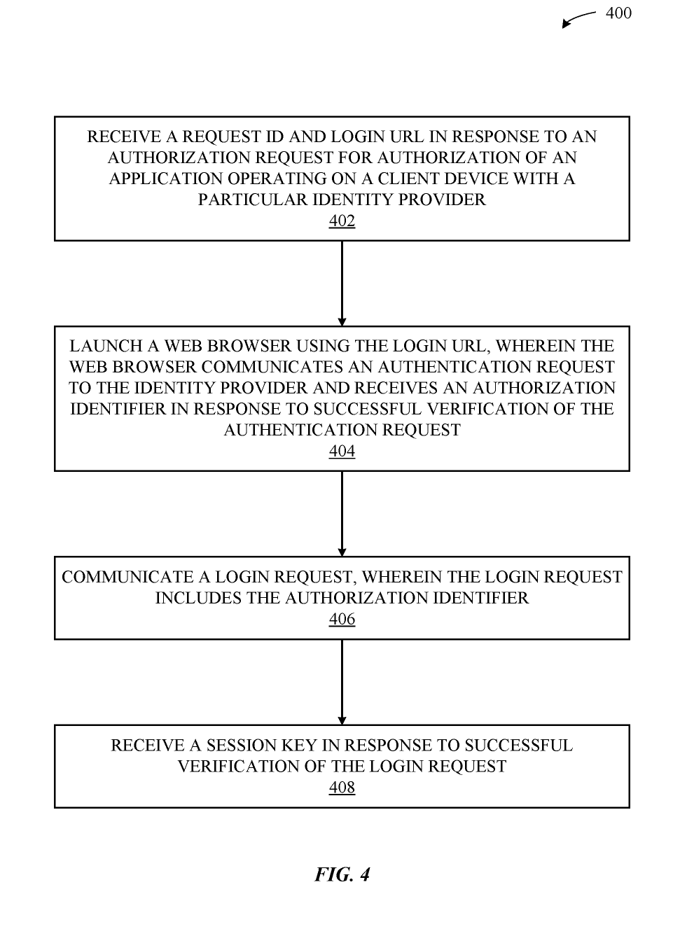

FIG. 4 illustrates a method 400 that is carried out by the client device 110/application 118 operating at the client device 110 of FIG. 1, according to some embodiments. As shown in FIG. 4, the method 400 begins at step 402, where the application 118 (executing on client device 110) receives, from the authentication server device 120, a request ID and a login URL in response to an authorization request. As previously described with respect to steps 210 and 212 of FIG. 2A, the authorization request is issued by application 118 and requests authorization with the identity provider 140. The identity provider 140 represents a particular identity provider that is selected from a list of identity providers that can be used for authentication/authorization.

At step 404, the client device 110 launches the web browser 205 using the login URL received from the authentication server device 120. The web browser 205 displays the website of the identity provider 140, wherein the user can be prompted to provide their credentials (e.g., a user ID/password combination, etc.). In particular, as previously described with respect to step 216 of FIG. 2B, the web browser 205 can communicate an authentication request to the identity provider 140, where the authentication request can include the credentials, the client ID and the request ID. In some implementations, the web browser 205 can receive an authorization identifier from the authentication server device 120 in response to a successful verification of the authentication request. In particular, the authorization identifier is generated in response to a successful verification of authorization information associated with the authentication request, as previously described with respect to steps 222 and 224 of FIG. 2B. At step 406, the application 118 communicates a login request to the authentication server device 120, where the login request includes the authorization identifier and the request ID. At step 408, the application 118 establishes a secure communication channel with the authentication server device 120 in response to a successful verification of the login request (as previously described with respect to steps 230, 232, and 234 of FIG. 2C). In some implementations, the secure communication channel is established based on a session key received from the authentication server device 120.

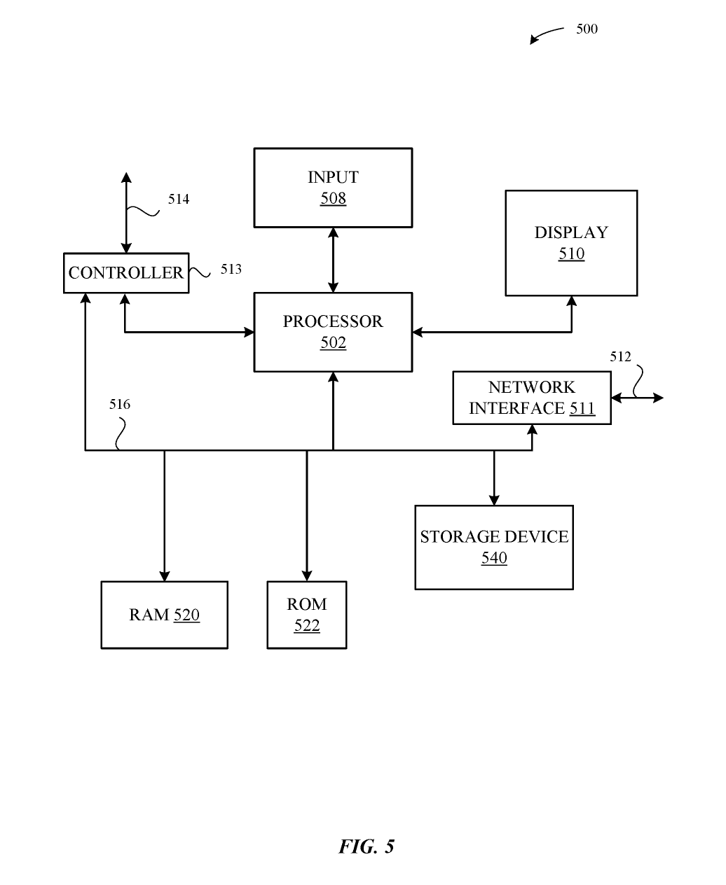

FIG. 5 illustrates a detailed view of a computing device 500 that can represent the various computing devices described herein, according to some embodiments. In particular, the detailed view illustrates various components that can be included in the client device 110, the authentication server device 120, and/or the identity provider 140 illustrated in FIG. 1. As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Still further, the computing device 500 can include a display 510 (screen display) that can be controlled by the processor 502 to display information to the user (for example, email interface described herein). A data bus 516 can facilitate data transfer between at least a storage device 540, the processor 502, and a controller 513. The controller 513 can be used to interface with and control different equipment through and equipment control bus 514. The computing device 500 can also include a wired or wireless network/bus interface 511 that couples to a data link 512. In the case of a wireless connection, the network/bus interface 511 can include a wireless transceiver.

The computing device 500 also includes the storage device 540, which can comprise a single disk or a plurality of disks (e.g., hard drives, spinning disks, magnetic storage disks, etc.), and includes a storage management module that manages one or more partitions within the storage device 540. In some embodiments, storage device 540 can include any type of non-volatile memory, flash memory, semiconductor (solid state) memory or the like. The computing device 500 can also include a Random Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of the computing device 500.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for authenticating an application, the method comprising:
at an authentication server device:
receiving authorization information from a web browser, wherein the authorization information is associated with an authentication request issued by the web browser to a particular identity provider;
generating an authorization identifier in response to a successful verification of the authentication request with the particular identity provider;
communicating the authorization identifier to the web browser;
verifying a login request received from the application based on the authorization identifier; and
enabling secure communication between the application and the authentication server device in response to a successful verification of the login request.

2. The method of claim 1, wherein the authentication request includes:
(i) login information,
(ii) a client identifier associated with the particular identity provider, and
(ii) a request identifier provided to the application by the authentication server device.

3. The method of claim 2, wherein the authorization information includes an authorization code issued by the particular identity provider and the request identifier.

4. The method of claim 2, wherein the authorization identifier includes a random code or secret that is linked to the login information.

5. The method of claim 3, wherein the authorization identifier is generated based on the authorization code.

6. The method of claim 1, further comprising:
storing a list of identity providers and one or more client identifiers associated with each identity provider in the list of identity providers, wherein the particular identity provider is selected from the list of identity providers.

7. The method of claim 1, wherein the login request includes the authorization identifier and a request identifier.

8. The method of claim 7, wherein verifying the login request comprises:
comparing the authorization identifier and the request identifier associated with the login request with information stored at the authentication server device.

9. The method of claim 1, wherein enabling the secure communication between the application and the authentication server device comprises:
generating a session key for the application.

10. A server computing device comprising:
at least one processor; and
at least one memory configured to store instructions that, when executed by the at least one processor, cause the server computing device to:
generate an authorization identifier in response to a successful verification of authorization information received from a web browser, wherein the authorization information includes an authorization code issued by an identity provider;
communicate the authorization identifier to the web browser;
verify a login request received from an application based on the authorization identifier; and
enable secure communication between the application and the server computing device in response to a successful verification of the login request.

11. The server computing device of claim 10, wherein the authorization information further includes a request identifier associated with an authorization request for authorization with the identity provider.

12. The server computing device of claim 10, wherein the authorization identifier is generated based on the authorization code.

13. The server computing device of claim 10, wherein the login request includes the authorization identifier and a request identifier.

14. The server computing device of claim 13, wherein verifying the login request comprises:
comparing the authorization identifier and the request identifier associated with the login request with information stored at the server computing device.

15. The server computing device of claim 10, wherein enabling the secure communication between the application and the server computing device comprises:
generating a session key for the application.

16. At least one non-transitory computer-readable medium configured to store instructions that, when executed by at least one processor included in a computing device, cause the computing device to perform steps that include:
receiving a request identifier and a login uniform resource locator (URL) in response to an authorization request for authorization of an application with an identity provider;
launching a web browser using the login URL;
receiving an authorization identifier via the web browser;
communicating a login request, wherein the login request includes the authorization identifier; and
establishing a secure communication channel in response to a successful verification of the login request.

17. The at least one non-transitory computer-readable medium of claim 16, wherein the login request further includes the request identifier.

18. The at least one non-transitory computer-readable medium of claim 16, wherein the authorization identifier is based on an authorization code provided by the identity provider.

19. The at least one non-transitory computer-readable medium of claim 16, wherein the login request is verified based on the authorization identifier.

20. The at least one non-transitory computer-readable medium of claim 16, wherein the secure communication channel is established with a server device based on a session key.
